(19) United States
(12) Patent Application Publication
(10) Pub. No.: US 2011/0067226 A1
(43) Pub. Date: Mar. 24, 2011

(54) Method and apparatus for making a workpiece and the workpiece

(76) Inventor: Steven Westbrook, Dunlap, CA (US)

(21) Appl. No.: 12/586,533

(22) Filed: Sep. 22, 2009

(51) Int. Cl. B23Q 3/06; B23B 35/00; F41C 3/00

(52) U.S. Cl. 29/559; 408/1 R; 29/283; 408/241 G; 42/106

(57) ABSTRACT

A method for making a workpiece having an operation station comprising the steps of: forming a passage communicating with said operation station of the workpiece; installing a predetermined link mounted in the operational station; and positioning resilient means on the link operable to return a portion of the workpiece to a ready position after use, a method and apparatus for forming said workpiece and the resulting workpiece.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a method and apparatus for making a workpiece and the workpiece and, more particularly, to such a method and apparatus and workpiece which have particular utility in application to improving the dependability of existing workpieces as well as workpieces at the time of manufacture.

(2) Description of the Prior Art

A workpiece of virtually any type can be improved during its manufacture, as well as thereafter, by the application of improved methods, apparatuses and technology. Such techniques, modifications and the like can relate to improved operation of the workpiece, improved performance, improved durability and a host of other beneficial results. Where the application of a method and apparatus in a particular environment produce a plurality of beneficial results, a truly significant departure from conventional practice may have been created.

For example, in the case of firearms, and particularly of the handgun type, the desired compact nature of the weapon, the desirability for rapid and dependable performance, the capacity for containing the greatest number of projectiles and many other such considerations frequently compete with each other for emphasis in the design and specific construction of the weapon. The resulting compromise is nearly always less than would be desirable with respect to one or more of these considerations. This is true of all types of handguns, such as revolvers and pistols, as well as in the case of other types of weapons.

In the case of firearms, for example, semi-automatic firearms, the sequence of operation which must take place, as well as the capabilities desired of the weapon, directly control the design which is adopted. In general, the sequence of operation is, of necessity, to pull the trigger, or other actuating mechanism, thereby causing the firearm to release a firing pin into proper engagement with the projectile in the firing chamber; to absorb shock resulting from the projectile being fired; dependably to eject the shell casing from the firing chamber; and to replace the fired projectile in the firing chamber with another unfired projectile so as to enable the weapon again to be fired. These steps must be performed in a designated sequence which must occur so rapidly as to be virtually simultaneous.

As a direct consequence of the demands of such operation, there are inherent weaknesses in key internal elements which can periodically break, or jam, immediately rendering the weapon unusable. This can have dire consequences, or, at very least, result in a frustrating and often lengthy delay for repair or adjustment before the weapon can again be used. Obviously, in the case of combat, law enforcement as well as in other environments, a firearm that fails to function can result in the loss of life of the firearm's user.

One such weakpoint which plagues the operation of such weapons is the trigger mechanism. This mechanism is obviously central to the proper operation of the weapon. Since depression of the trigger initiates the above-summarized sequence of operation, a failure in this mechanism can infrequently cause of failure of the weapon. Conventional methods for the repair of such trigger and related mechanisms are time consuming, undependable, expensive and normally result in installing the same type of mechanism which failed in the first place. Certain brands of handguns are notorious for such circumstances, but all handguns suffer from this same problem to varying degrees. Repair by the manufacturer of the weapon, is inadequate because it usually similarly involves installation of another of the same component which failed. Additionally, connective manufacture is frequently expensive and slow. Thus, the conventional solutions to these problems are entirely unsatisfactory in most instances.

Therefore, it has long been known that it would be desirable to have a method and apparatus for making a workpiece and the resulting workpiece which afford the capability of producing a superior workpiece; which are capable of operation on and with a wide variety of work products including weapons; which produce a workpiece which can perform a series of steps in rapid sequence substantially without operational failure; which possess a dependability of operation in the workpiece so as to be substantially without the possibility of failure; which perform with a simplicity of construction and yet has the capability of performing a series of operations in very rapid sequence; which operate in a manner superior to prior art devices; and which are otherwise completely successful in achieving their operational objectives.

### BRIEF SUMMARY OF THE INVENTION

Therefore, it is an object of the present invention to provide an improved method and apparatus for making a workpiece and the resulting workpiece.

Another object is to provide such a method and apparatus which are operable to produce a workpiece superior to those conventionally available.

Another object is to provide such a method and apparatus which can be employed in a wide variety of operative environments.

Another object is to provide such a method and apparatus which are operational on both existing as well as new workpieces at the time of manufacture.

Another object is to provide such a method and apparatus which are particularly well suited to the production of a workpiece which must perform a series of steps in very rapid sequence, conventionally being is susceptible to failure.

Another object is to provide such a method and apparatus which have particular utility in the manufacture or repair of workpieces, such as firearms and the like.

Another object is to provide such a method and apparatus which are operable in one environment of use significantly to improve upon the operation and dependability of firearms and particularly those which are subject to failure during conventional operation.

Another object is to provide such a method and apparatus which can be employed rapidly and dependable to accomplish their operational objectives and which have application to both workpieces at the time of manufacture, as well as in retrofitting an existing workpiece by both experts as well as laymen.

Another object is to provide such a method and apparatus which are operable to modify a workpiece for the improved performance thereof under difficult circumstances.

Another object is to provide a workpiece, and particularly a weapon, which operates with dependability not heretofore achieved in the art.

Further objects and advantages are to provide improved elements and arrangements thereof in a method and apparatus and the resulting workpiece for the purpose described which are dependable, economical, durable and fully effective in accomplishing their intended purposes.

These and other objects and advantages are achieved, in the preferred embodiment of the present invention, in a method and apparatus for making a workpiece including the steps of: removing a selected portion of the workpiece so as to leave a predetermined operational area within the workpiece; forming a passage communicating with the operational area; and installing a predetermined replacement portion for the selected portion through the passage and into the operational area.

### BRIEF DESCRIPTION OF THE SEVERAL VIEWS OF THE DRAWINGS

FIG. 1 is a fragmentary longitudinal vertical section of a prior art workpiece, in this example a firearm, showing the conventional trigger mechanism using a torsion spring for the trigger return.

FIG. 2 is a fragmentary, longitudinal, vertical section of the workpiece of FIG. 1 shown in a partially disassembled condition and illustrating a first step in the method of the present invention.

FIG. 3 is a fragmentary, longitudinal, vertical section of the workpiece of FIG. 1 shown in a partially disassembled condition and illustrating a second step in the method of the present invention; that is, drilling a spring seat.

FIG. 4 is a fragmentary, longitudinal, vertical section of the workpiece of FIG. 1 and illustrating a third step in the method of the present invention; that is, drilling a guide pin hole.

FIG. 5 is a fragmentary, longitudinal, vertical section of the workpiece of FIG. 1 shown in a partially disassembled condition and showing a fourth step in the method of the present invention; that is, tapping the hole in the front magazine well wall.

FIG. 6 is a fragmentary, longitudinal, vertical section of the workpiece of FIG. 1 shown in a partially disassembled condition and showing a fifth step in the method of the present invention; that is installation of a setscrew.

FIG. 7 is a side elevation of a vice, a locking lug jig removably clamped in the vice, the barrel slide locking lug of the workpiece and a file assembly all of the present invention.

FIG. 8 is a side elevation of the pistol of the present invention shown in its fully assembled configuration and with portions thereof shown in hidden lines.

FIG. 9 is a longitudinal vertical section of the workpiece of the present invention ready for the completion of the assembly thereof.

FIG. 10 is an exploded, perspective view of the trigger mechanism of the workpiece of the present invention. The workpiece of the present invention is in its fully assembled form in FIG. 8 with these operative components of FIG. 10 shown in hidden lines therein.

### DETAILED DESCRIPTION OF THE INVENTION

### Prior Art

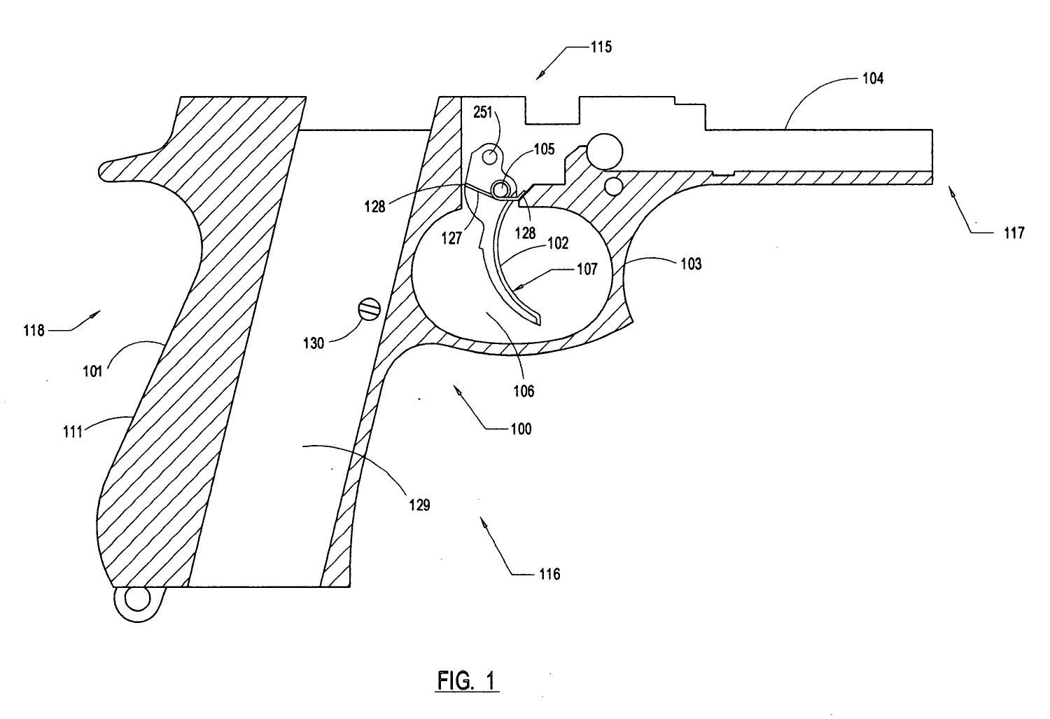

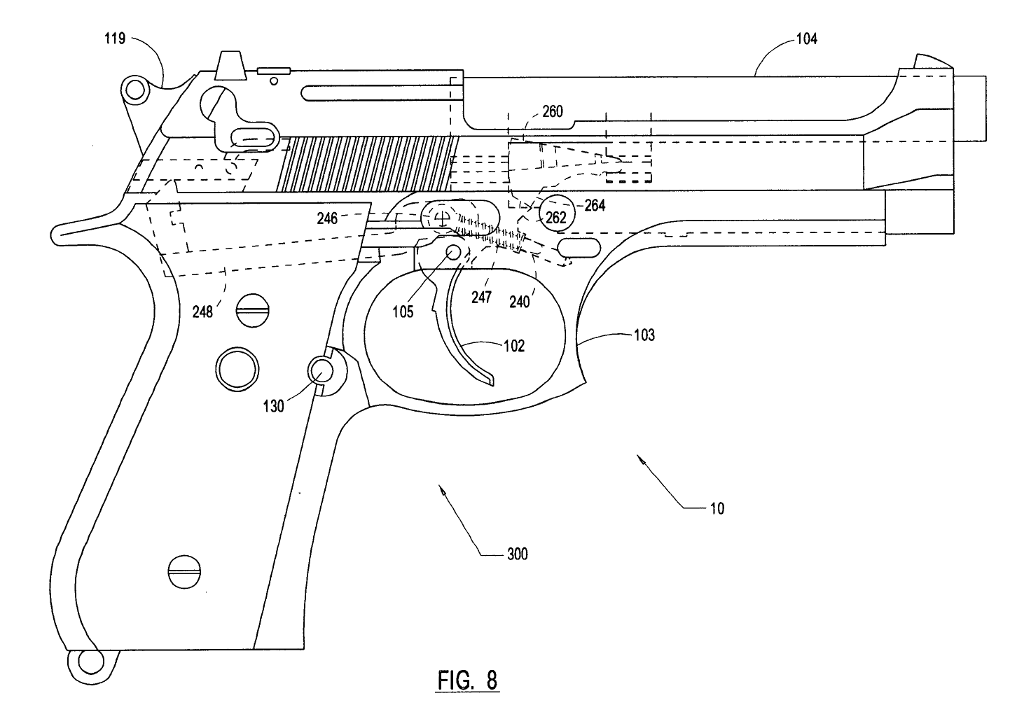

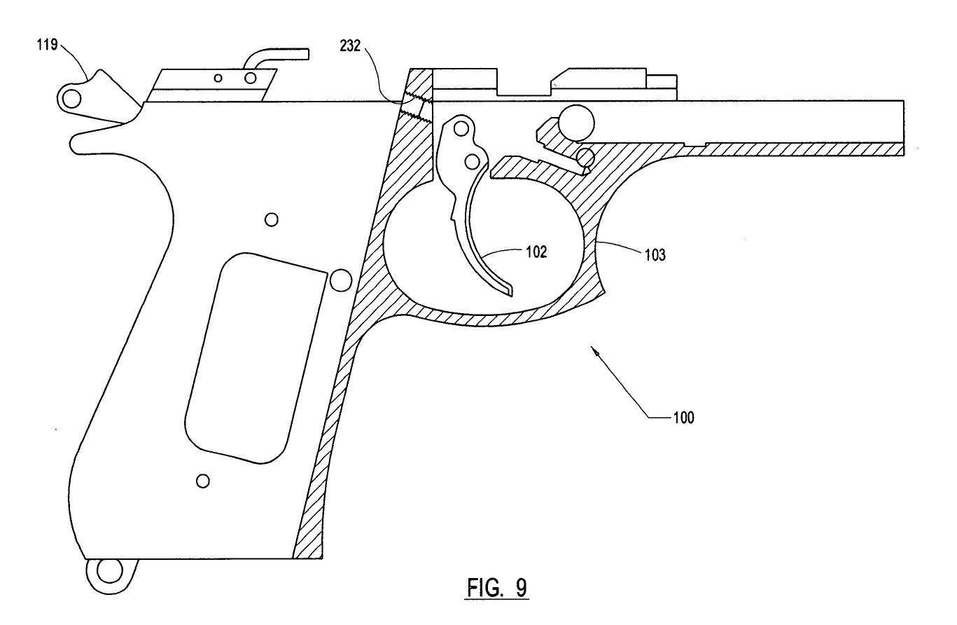

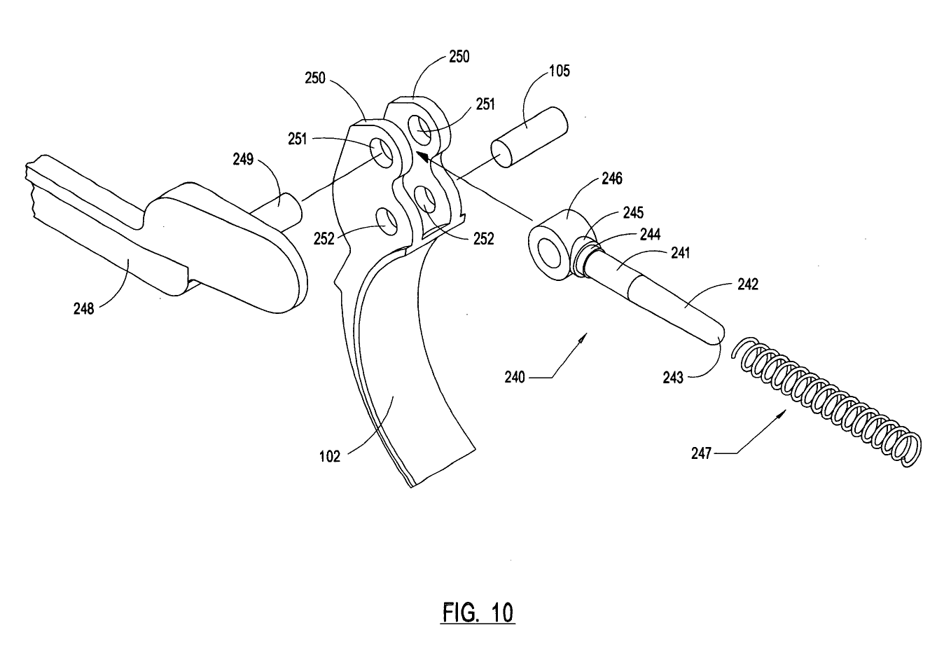

The apparatus or workpiece of the present invention is generally indicated by the numeral 10 in FIG. 8 where it is shown in its fully completed or converted form. However, for purposes of descriptive convenience, reference will first be made to a conventional weapon, firearm, handgun, or workpiece 100 which is to be converted in accordance with the method of the present invention. The conventional workpiece is shown in FIG. 1 in a fragmentary, longitudinal, vertical section. In an effort to avoid being unnecessarily repetitive, this conventional workpiece is described herein in general terms. This will afford a background for a full disclosure of all of the subject matter which individually constitute the method and apparatus for making a workpiece and the workpiece all of the present invention.

Accordingly, with reference to FIG. 1, the workpiece 100, in general, has a handle 101, a trigger 102, a trigger guard 103 and a barrel mounting assembly 104. The conventional workpiece has a trigger pivot pin 105 on which the trigger is mounted for pivotal movement thereabout. The workpiece has an operation station generally indicated by the numeral 106.

Again for illustrative convenience, in general, the workpiece or pistol 100 can be viewed as having a butt, or handle portion 111. The pistol has a top portion 115 and an opposite bottom portion 116. The pistol has a front portion 117 and an opposite rear portion 118. The pistol has a hammer 119.

A conventional torsion spring 127 is mounted on, and extended about, trigger pivot pin 105 as shown in FIG. 1. The torsion spring has opposite ends 128 which are individually mounted on the workpiece frame on opposite sides of the trigger 102, as shown in FIG. 1. The workpiece has a magazine well 129 which is adapted to receive a magazine, not shown, holding a plurality of cartridges, also not shown. A magazine release mechanism 130 is mounted on the handle 101 and extends through the magazine well wall. The magazine release mechanism is operable releasably to retain the magazine in the magazine well. The magazine release mechanism is also operable to release the magazine for removal of the magazine from the magazine well.

This conventional workpiece 100 is, purely for illustrative convenience, a semi-automatic pistol. In such pistols, as previously noted, the torsion spring 127 and other conventional springs are notoriously subject to structural failure. Such breakage can occur at one or both of the opposite ends 128 thereof, or in the torsion spring 127 itself which extends about the trigger pivot pin 105. In any case, such breakage prevents the trigger from being returned to the start, or firing position. This renders the pistol inoperable because there is, in such case, nothing operable to return the trigger to the start, or firing position.

### Method and Apparatus for Making a Workpiece and the Workpiece

### All of the Present Invention

The method and apparatus for making a workpiece and the workpiece of the present invention are all individually believed to be new and nonobvious as those standards are interpreted under the Patent Laws of the United States. While there are conventional individual elements in the workpiece, these are discussed herein only to the extent necessary to have a clear understanding of the subject invention.

The workpiece 100 is, at this point, conventional. The conventional workpiece, and the failings thereof heretofore setforth in the illustrative example, are present in many specific types of pistols including the semi-automatic Beretta pistol shown herein.

The interoperation of elements of the present invention with conventional elements reveals the full invention hereof including the method and apparatus and resulting workpiece. The subject invention is, however, not limited in any respect to use in combination with the specific conventional workpiece shown and described herein.

The pistol 100 has a spring pin 105. A torsion spring 127 extends about the spring pin, as shown in FIG. 1. The torsion spring has opposite ends 128 which are mounted on the pistol so as to maintain the torsion in the torsion spring. The pistol has a magazine well 129 adapted to receive a conventional magazine, not shown, housing a plurality of projectiles, or bullets, also not shown. A release mechanism 130 is mounted so as releasably to retain the magazine in the magazine well. The release mechanism has a control, not shown, to operate the release mechanism and accessible from the exterior of the handle 101.

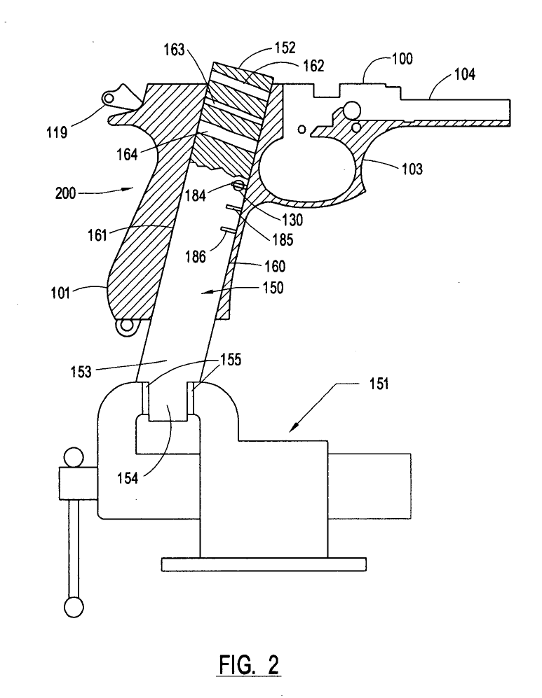

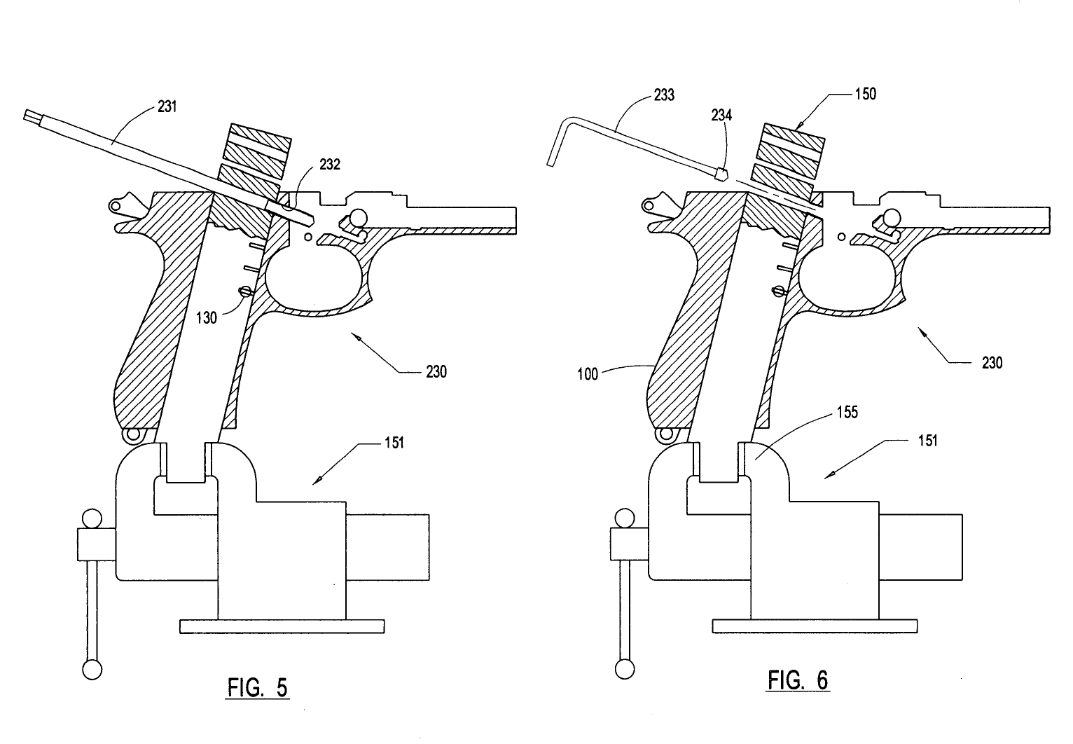

The method and apparatus of the present are adapted readily to convert the pistol 100 from its conventional form, to the pistol, or workpiece, of the present invention shown in FIG. 8. This method and apparatus of the present invention are best shown in FIGS. 2, 3, 4, 5, and 7. Using the release mechanism 130, the magazine is removed from the magazine well 129 so as to leave the magazine well entirely empty and unobstructed, as shown in FIG. 1. Also in preparation, the trigger pivot pin 105, torsion spring 127 and trigger 102 of the pistol 100 are removed from the pistol.

Referring more particularly to FIG. 2, the practice of the method and apparatus of the present invention include a drill guide generally indicated by the numeral 150. The drill guide, as will subsequently be described, is retained in a vice 151, or other means for holding an object in fixed position. The vice is mounted, for example, on a workbench, not shown. The drill guide is not conventional and constitutes part of the method and apparatus of the present invention. Referring more particularly to FIG. 2, the drill guide has an upper end portion 152 and an opposite lower end portion 153. The lower end portion has a projection 154 dimensioned to be received in the jaws or chuck 155 of the vice so that the drill guide is firmly held in the upright, slightly canted attitude, shown in FIG. 2. The specific angle of cant of the drill guide as well as its shape and size, are shown in FIGS. 2 through 6 and are part of the subject invention, as will hereinafter become more clearly apparent.

As shown in FIG. 2, the drill guide 150 has a front side 160 and an opposite rear side 161. The front and rear sides are substantially parallel to each other. The upper end portion of the drill guide, in the preferred embodiment, has three drill guide passages extending therethrough in the predetermined positions shown in FIG. 2.

For purposes of distinguishing from among the drill guide passages, the upper drill guide passage is identified by the numeral 162, the central drill guide passage is identified by the numeral 163, and lower drill guide passage is identified by the numeral 164. The upper, central and lower drill guide passages are substantially parallel to each other and are canted at a predetermined angle relative to the front side and rear side of the drill guide. Furthermore, the upper, central and lower drill guide passages are of different diameters corresponding to their respective uses. The upper drill guide passage is of a predetermined intermediate diameter. The central drill guide passage is of a predetermined smaller relative diameter. The lower drill guide passage is of the largest relative diameter.

The drill guide 150 has a top drill guide notch 184, a central drill guide notch 185 and a bottom drill guide notch 186. These drill guide notches are shown in FIGS. 2, 3, 4, 5 and 6. The notches are disposed in predetermined spaced relation to each other corresponding to the predetermined space relation of the upper drill guide passage 162, the central drill guide passage 163 and the lower drill guide 164.

As previously discussed, in accordance with the practice of the method of the present invention using the apparatus of the subject invention, the magazine, not shown, is removed from the magazine well 129 using the magazine release mechanism 130. Such removal of the magazine leaves the magazine well entirely vacant and unobstructed, except for the small extension of a portion of the release mechanism into the magazine well.

The next step calls for sliding the pistol 100 downwardly about the drill guide 150, as shown in FIGS. 2 through 6. The drill guide is dimensioned slidably to be received in the magazine well 129 and is first moved to the position shown in FIG. 2. The magazine release mechanism releasably engages the top drill guide notch 184 to retain the pistol in an upper position 200 on the drill guide, as shown in FIG. 2. Consequently, the pistol is held in this upper position for the performance of the next step in the method of the subject invention.

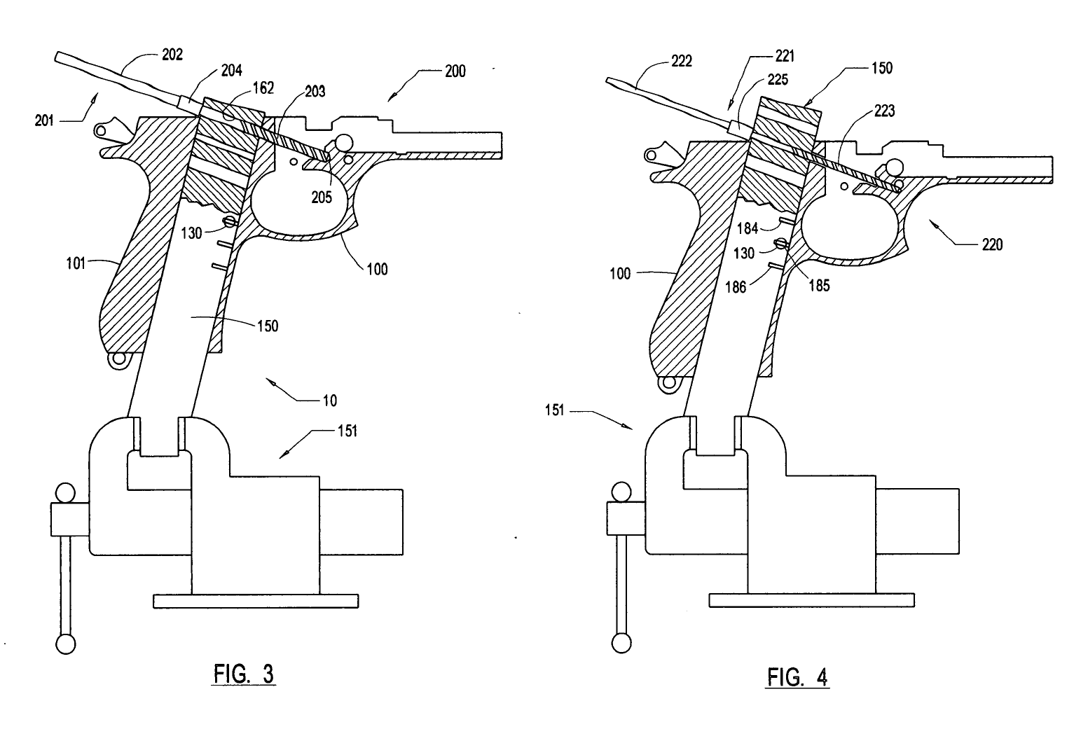

The next step is shown in FIG. 3. A first drill bit 201 is extended into and through the upper drill guide passage 162. For purposes solely for illustration, it will be understood that the first drill bit is 0.156 inches in diameter. The first drill bit has a drive portion 202 on the left, as viewed in FIG. 3 and an externally screwthreaded drill portion 203 on the right, as viewed in FIG. 3. A central stop collar 204 intermediate the drive portion and the drill portion is mounted on the first drill bit in a predetermined position. The screwthreaded drill portion of the first drill bit has a terminal end 205. The outer diameter of the central collar is larger than the inner diameter of the upper drill guide passage. Thus, the depth of the drilling within the pistol is limited by engagement of the central stop collar with rear side 161 of the drill guide 150, as shown in FIG. 3. The first bit is rotated, using a suitable drill, not shown, to “bump” the terminal end of the drill bit against the front magazine well wall to establish a start point for the following steps of the method. The drill is continued to be operated forwardly over the trigger opening. The drill is continued to be operated into the release latch of the pistol 100 a predetermined distance. The stop collar 204 stops the drill bit at the correct drilling depth. The depth of the base, so formed, extends inwardly of the pistol to the position shown in FIG. 8 to the right of the trigger pivot pinhole of the pistol.

The next step in the method is best shown in FIG. 4. To accomplish this step, the magazine release mechanism 130 is operated to release the pistol 100 on the drill guide 150. The pistol is pushed downwardly on the drill guide until the magazine release mechanism is releasably received in the central drill guide notch 185. In this central position 220, the central drill guide passage is directly aligned with the base formed in the proceeding step.

As previously noted, the central drill guide passage 163 is of smaller diameter than the upper and lower drill guide passages 162 and 164 respectively. For purposes of illustration only it will be understood that the second drill bit is 0.125 inches in diameter. At this time a second drill bit 221 is inserted into the central drill guide passage. The second drill bit has a drive portion 222 and an externally screwthreaded drill portion 223 which extends to a terminal end 224. A stop collar 225 is mounted on the second drill bit is a predetermined position substantially midway between the drive portion and the drill portion thereof.

The second bit 221 is pushed through the previously drilled hole in the front magazine well wall and such drilling continued in forward movement over the trigger opening bounded by the trigger guard 103. Such drilling is continued until it reaches the prescribed depth into the release latch, as best shown in FIG. 4. The stop collar 225 on the second drill bit at this point engages the rear side 161 of the drill guide 150 to terminate any further penetration.

The next step in the method is again to operate the magazine release mechanism 130 and move the pistol downwardly until the bottom drill guide notch is engaged by the magazine release mechanism 130. This holds the drill guide 150 in the lower position 230 shown in FIG. 4.

A tap 231 is then inserted in the lower drill guide passage 164 and to the bottom of the drill guide hole. The tap is used to form screwthreads 232 in the bottom of the hole. A suitable thread cutting oil is used to assist in forming the screwthreads in the front magazine well wall.

Using an Allen wrench 233, a setcrew 234 is placed on to the end of the Allen wrench and screwthreadably secured in the screwthreads 132. The setscrew does not protrude into the trigger well.

The method and apparatus include a guide pin 240 which is then installed in the pistol 100. The guide pin has a central shaft portion 241 which is substantially cylindrical. The guide pin has a tapered portion 242 having a rounded terminal end 243. The guide pin has a spring seat 244 bounded by a spring shoulder 245. The guide pin, opposite the rounded terminal end 243, has a connection ring 246, as best shown in FIG. 10. The connection ring is mounted on the transfer bar pin 249 of the transfer bar 248 between the upper clevis ears 250, in the holes 251 thereof. The upper clevis ears also have lower holes 252 in which the trigger pivot pin 105 is received, all as best shown in FIG. 10. A compression spring 247 is received about the guide pin positioned so as to be captured between the spring shoulder 245 and the shoulder formed by the first drill bit 201.

As can best be seen in FIG. 8, the trigger 102 is maintained in a ready position by the compression spring 247 disposed in its expanded condition so as resiliently to maintain the trigger in a position ready for use, as shown in FIG. 8. When the pistol 100 is to be fired, the trigger is depressed by movement in a clockwise direction, as viewed in FIG. 8. The compression spring resiliently resists such movement in that it is captured between the spring shoulder 245 and the shoulder formed by the first drill bit 201. In the meantime, the tapered portion 242 of the guide pin 240 slide downwardly in the passage formed by the second drill bit thereby accommodating such motion and firing, or discharging, the pistol. When finger pressure is removed from the trigger 102, the compression spring 247 moves the trigger in a counter-clockwise direction, as shown in FIG. 8, again to the ready position.

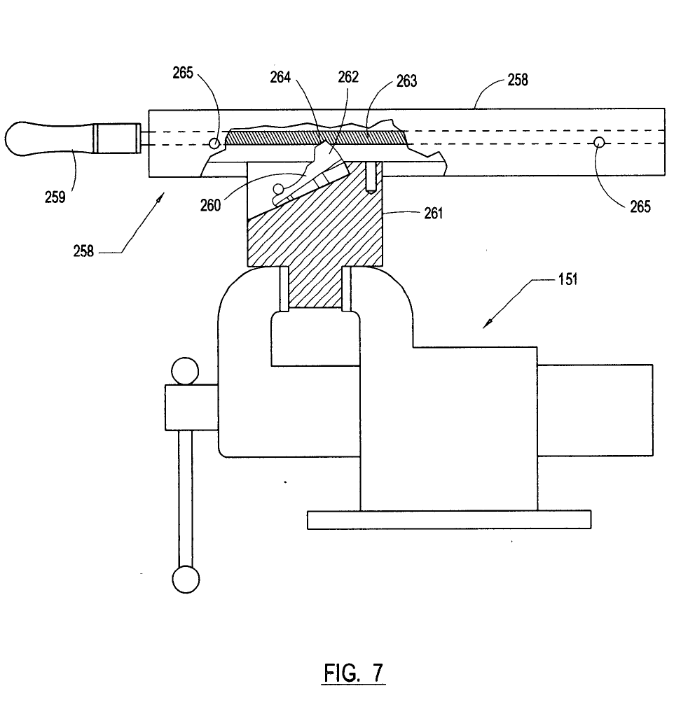

As a consequence of the foregoing method of the present invention, it is preferred that another modification be made in the pistol 100 using a file holder and depth gauge 258 having a handle 259. This is best shown in FIG. 7. It is preferred that the barrel slide locking lug 260 be modified to ensure clearance between the guide pin 240 and the barrel slide locking lug. This step of the method is performed as best shown in FIG. 7. An appropriate locking lug jig 261 is placed in the vice 151 and locked into position. The barrel slide locking lug 260 is mounted in the locking lug jig in inverted relation. Using the metal file 263, borne by the file holder and depth gauge 258, a clearance notch 264 is formed in the locking lug foot. Stops 265 shown in FIG. 7 prevent the metal file from cutting a deeper clearance notch. The file holder and depth gauge is used to make the clearance notch 264 3/16 of an inch in size and the fixed depth of 0.078 inches in this illustrative embodiment. This insures that during operation, there is no interference between the guide pin 240 and the locking lug foot 262.

For purposes of distinguishing the conventional pistol 100 from the resulting pistol or workpiece of the present invention, the resulting pistol or workpiece is identified by the numeral 300. The resulting pistol or workpiece 300 of the present invention operates with a high degree of accuracy while being entirely dependable. The guide pin 240 and compression spring 247 interoperate to provide such dependability that there is little or no chance of failure such as by dislodgment or breakage of a conventional spring structure as is experienced with conventional apparatuses, handguns, or other workpieces as previously setforth.

As heretofore described in detail in the illustrative embodiment hereof, the method of the present invention using, for example, the drill guide 150, the first and second drill bits 201 and 221; the tap 231; the Allen wrench 233; the guide pin 240 and compression spring 247; and the file holder and depth gauge 258 ensure that the conversion is performed precisely each time. The invention hereof ensures this precision even for people with limited skills. Furthermore, the method and apparatus can be performed rapidly and repeatedly without variation providing the same precision in each case.

Therefore, the method and apparatus for making a workpiece and the resulting workpiece of the present invention afford the capability of producing a superior workpiece; are capable of operation on and with a wide variety of workpieces including weapons; produce a workpiece which can perform a series of steps in rapid sequence substantially without operational failure; possess a dependability of operation in the workpiece so as to be substantially without the possibility of failure; perform with a simplicity of construction and yet have the capability of performing a series of operations in very rapid sequence; operate in a manner superior to any prior art devices; and are otherwise completely successful in achieving their operational objectives.

Although the invention has been herein shown and described in what is conceived to be the most practical and preferred embodiments, it is recognized that departures may be made therefrom within the scope of the invention which is not to be limited to the illustrative details disclosed.

1. A method for making a workpiece having an operation station comprising the steps of:
forming a passage communicating with said operation station of the workpiece;
installing a predetermined link mounted in the operational station; and
positioning resilient means on said link operable resiliently to retain said link in a ready position.

2. The method of claim 1 including the step of:
holding the workpiece in a substantially fixed work position.

3. The method of claim 2 wherein the holding step is performed prior to said forming step.

4. The method of claim 2 wherein said workpiece is a firearm having a magazine removably received in a magazine well and including the steps of:
detaching the magazine from said magazine well; and
inserting a member dimensional substantially to conform to said magazine well, in said magazine well to hold the firearm substantially in the fixed work position.

5. The method of claim 4 wherein the member has a drill guide extending therethrough along a predetermined course, and including the steps of:
extending a drill bit through said drill guide into said operation station; and
drilling into the firearm to form a predetermined base in said operation station and wherein said installing step includes placing said predetermined link in the operation station extending into said predetermined base.

6. The method of claim 5 wherein the firearm is a pistol having a trigger mechanism, and wherein in said installing step said link is a guide pin mounting a spring thereabout and the guide pin is of a sufficient length so as to be received in said base of the operation station.

7. An apparatus for making a workpiece, said workpiece having a passage extending from an external opening and inwardly of the workpiece, said apparatus comprising a drill guide dimensional slidably to be received in said passage through the external opening and operable to hold the workpiece in a predetermined work position and having at least one guide passage extending through the drill guide along a course in substantial alignment with a predetermined portion of the workpiece; and means for cutting into said predetermined portion of the workpiece to form a base of a predetermined width and depth in the workpiece to provide space for the installation of an element of predetermined size operable in the use of the workpiece.

8. The apparatus of claim 7 wherein the workpiece has a trigger mechanism which is disposed at a predetermined angle to said workpiece, said base so formed being of a predetermined length; said workpiece has a magazine well of predetermined size; and wherein said drill guide is dimensioned slidably to be received in said magazine well so as to be substantially interlocked with the workpiece and wherein the apparatus has means for holding said drill guide in a substantially upright attitude with said base disposed in a predetermined attitude extending along a longitudinal axis of reference, and a drill assembly having a drill bit dimensioned to be inserted through the guide passage of the drill guide for the formation of said base extending along said longitudinal axis of reference.

9. The apparatus of claim 7 in which said workpiece has a magazine control mechanism which extends into said magazine well and wherein with the drill guide in said work position an engagement portion of the drill guide engages said magazine control mechanism to retain said drill guide in the work position.

10. The apparatus of claim 9 wherein the drill guide has a plurality of said guide passages and individually corresponding engagement portions whereby the drill guide can selectively be positioned in individual engagement with said magazine control mechanism to place one of said plurality of guide passages in the work position and including a plurality of said drill bits individually corresponding to the character of the result desired for said passage formed by said cut of the drill bit.

11. The apparatus of claim 10 wherein the drill bits individually have shoulder portions mounted thereon in predetermined individual positions thereby controlling the depth of said cuts.

12. The apparatus of claim 10 wherein the guide passages are of predetermined different diameters such that only one drill bit is dimensioned to be received in each guide passage.

13. The apparatus of claim 12 wherein a guide pin is mounted on said trigger mechanism at one end portion thereof and an opposite end portion slidably received in said base and coil spring is received on the guide pin extending thereabout compressably interconnecting said trigger mechanism and the shoulder about said base whereby said coil spring resiliently maintains said trigger mechanism in a ready position and when the trigger mechanism is activated, said coil spring is compressed about the guide pin as the guide pin moves in the base to accommodate the activation of the trigger mechanism and return said trigger mechanism to said ready position.

14. A workpiece comprising a body having a portion defining a receptacle deployed in substantially fixed relation relative to said body; an activating mechanism mounted on the body; a contact member mounted on the activating mechanism for movement between a ready position and an activating position; a work assembly operable to perform the work of said workpiece; means linking said contact member and the work assembly for transferring motion from the contact member of the activating mechanism to said work assembly; and a guide assembly for guiding movement between the activating mechanism to the work assembly.

15. The workpiece of claim 14 wherein said guide assembly has substantially a coil spring operatively interconnecting said body and the activating mechanism resiliently to retain said contact member in the ready position.

16. The workpiece of claim 15 wherein the guide assembly has a guide pin which interconnects said body and the activating mechanism for substantially reciprocal movement therebetween as the contact member moves between said ready position and said activating position and said coil spring extends about the guide pin resiliently to retain the contact member in the ready position.

17. The workpiece of claim 16 wherein said workpiece is a firearm containing a projectile, the contact member is a trigger of the firearm and said work assembly is operable, upon transferring motion from the contact member to the work assembly, to cause the work assembly to fire the projectile therefrom.
